(19) United States
(12) Patent Application Publication
(10) Pub. No.: US 2013/0154535 A1
(43) Pub. Date: Jun. 20, 2013

(54) Lockout switching strategy for preventing high voltage transition

(71) Applicants: Jackson Wai, Dunlap, IL (US); Mark Hartman, Peoria, IL (US); Thuong Le, Edwards, IL (US); Jesse Gerdes, Dunlap, IL (US)

(72) Inventors: Jackson Wai, Dunlap, IL (US); Mark Hartman, Peoria, IL (US); Thuong Le, Edwards, IL (US); Jesse Gerdes, Dunlap, IL (US)

(73) Assignee: CATERPILLAR INC., Peoria, IL (US)

(21) Appl. No.: 13/325,907

(22) Filed: Dec. 14, 2011

(51) Int. Cl. H02P 23/00; H02M 3/10

(52) U.S. Cl. 318/503; 363/97

(57) ABSTRACT

A protection circuit includes a first switch, a second switch and a third switch. The first switch, the second switch and the third switch are configured to generate lock signals indicative of an electrical voltage transition on the respective phases of a multi-phase power signal. A control circuit is configured to prevent the first switch from changing state if the second switch or third switch is changing state.

### TECHNICAL FIELD

This patent disclosure relates generally to lockout switching in motor controls and, more particularly to preventing drivers for more then one phase of a multi-phase electric machine from transitioning at the same time.

### BACKGROUND

Electric machines are used in a wide variety of industrial applications. For example, electric motors may be used to provide drive power to machines, such as a large mining truck, or a bulldozer. Machines increasingly use electric drive systems to provide propulsion for the machine. For example, passenger vehicles may use a hybrid drive system whereby a traditional gasoline powered engine and an electric motor are both used to provide propulsion for the vehicle. Machines, such as a railway engines and off-road vehicles may use a diesel powered engine to drive a generator, which provides electric power to a motor. The motor then provides propulsion for the machine.

Direct current (DC) and alternating current (AC) electric motors are known. A DC motor is designed to operate on DC electric power, while an AC motor is designed to operate on AC electric power. An AC motor generally contains a stationary stator having coils supplied with AC current to produce a rotating magnetic field. A rotor attached to the output shaft that is given a torque by the rotating magnetic field. A three-phase AC motor uses three-phase electric power to produce the rotating magnetic field. In a three-phase system, separate conductors carry three alternating currents at different phases. Likewise, multi-phase systems may use more then three phases of current.

AC motors are often supplied with three-phase power from a variable frequency drive or an invertor drive. The drives supply three independent phases of power to the AC motor. A controller typically manages the frequency and magnitude of the power produced by the drive. However, each phase is typically independently controlled. During certain periods, voltage and current spikes may be experienced at the motor due to transient conditions existing on more than one phase.

One control system for a three-phase motor is described in U.S. Pat. No. 4,825,132 (the '132 patent) issued to Gritter on Apr. 25, 1989. The '132 patent describes a control system that locks one phase of a three-phase signal. The phase is locked throughout the middle 60 degree interval of each phase. Although the '132 patent describes locking one phase of a three-phase signal, it does not adequately address a way of controlling each phase of a three phase signal in relation to certain conditions in the other phases.

### SUMMARY

The disclosure describes, in one aspect, a protection circuit for limiting an electrical voltage transition on at least a first phase, a second phase and a third phase of a multi-phase power bus. The protection circuit includes a first switch having a first upper gate configured to control a first upper gate signal and a first lower gate configured to control a first lower gate signal. The first switch is configured to control the first upper gate and the first lower gate in response to a first command signal indicative of the desired state of the first switch and generate a first lock signal indicative of an electrical voltage transition on the first phase changing state.

The protection circuit also includes a second switch having a second upper gate configured to control a second upper gate signal and a second lower gate configured to control a second lower gate signal. The second switch is configured to control the second upper gate and the second lower gate in response to a second command signal indicative of the desired state of the second switch and generate a second lock signal indicative of an electrical voltage transition on the second phase changing state. The protection circuit also includes a third switch having a third upper gate configured to control a third upper gate signal and a third lower gate configured to control a third lower gate signal. The third switch is configured to control the third upper gate and the third lower gate in response to a third command signal indicative of the desired state of the third switch and generate a third lock signal indicative of an electrical voltage transition on the third phase.

The protection circuit further includes a control circuit configured to control the first switch based on the first command signal, to control the second switch based on the second command signal and to control the third switch based on the second command signal. The control circuit is further configured to prevent the first switch from changing state if one of the second lock signal indicates the second switch is changing state or the third lock signal indicates the third switch is changing state.

In a further aspect, the present disclosure includes a controller for a multi-phase alternating current motor. The controller includes a modulator for each phase of the multi-phase alternating current motor. Each modulator is configured to generate a pulse width modulated signal.

The controller further includes a switch for each phase of the multi-phase alternating current motor. Each of the switches is responsive to the command signal for its respective phase and is configured to supply power to a phase of the alternating current motor. Each switch further has a minimum on time after changing states and the controller having a latency between the command signal changing states and the output of each switch. The controller also includes a lock generator for each phase of the multi-phase alternating current motor. Each of the lock generators is configured to generate a lock signal for a period during the latency between the command signal changing states and the output of the switch, the switch changing states and the minimum on time of the switch. The controller is configured to provide command signals to prevent each corresponding switch from changing states if a lock signal for one of the phases not associated with a particular corresponding switch is received.

In a further aspect, the present disclosure includes a method of controlling a multi-phase alternating current motor having a multi-phase power signal. For each phase of the multi-phase alternating current motor a command signal indicative of whether power should be supplied to a particular phase is generated. Power is supplied to a phase associated with the alternating current motor using a switch having a minimum on time after changing states and a latency between a command to change states and the output of the switch. A lock signal is generated for a period during the minimum on time after changing states and the latency between a command to change states and the output of the switch. The switch is prevented from changing states if the lock signal for another phase indicates another phase is changing states.

### BRIEF DESCRIPTION OF THE DRAWING(S)

FIG. 1 is a simplified electrical circuit diagram for a power circuit used in a electric machine control.

FIG. 2 is a simplified timing diagram for the generation of one phase of a multi-phase power signal in accordance with one embodiment of the disclosure.

FIG. 3 is a simplified timing diagram showing signals generated for two phases of the multi-phase power signal in accordance with one embodiment of the disclosure.

FIG. 4 is a flowchart for a method in accordance with the disclosure.

### DETAILED DESCRIPTION

This disclosure relates to systems and methods for managing power in a electric machine, such as may be used in a bulldozer, or other machine. Additionally, electric power generation systems (generators) may benefit from the advantages described herein. As can be appreciated, any other vehicle having a hybrid drive, electric-only, or direct series electric drive arrangement can benefit from the advantages described herein. Example machines that may benefit from the advantages described herein include, but are not limited to, bulldozers, off-highway trucks, track type machines, wheel loaders and excavators. However, any electric motor and/or generator system can benefit from the advantages described herein. Electrical power may be generated onboard by an alternator, generator, or another power-generation device, which may be driven by an engine or other prime mover. Alternatively, electrical power may be stored but not generated on-board or may be delivered to the machine as needed.

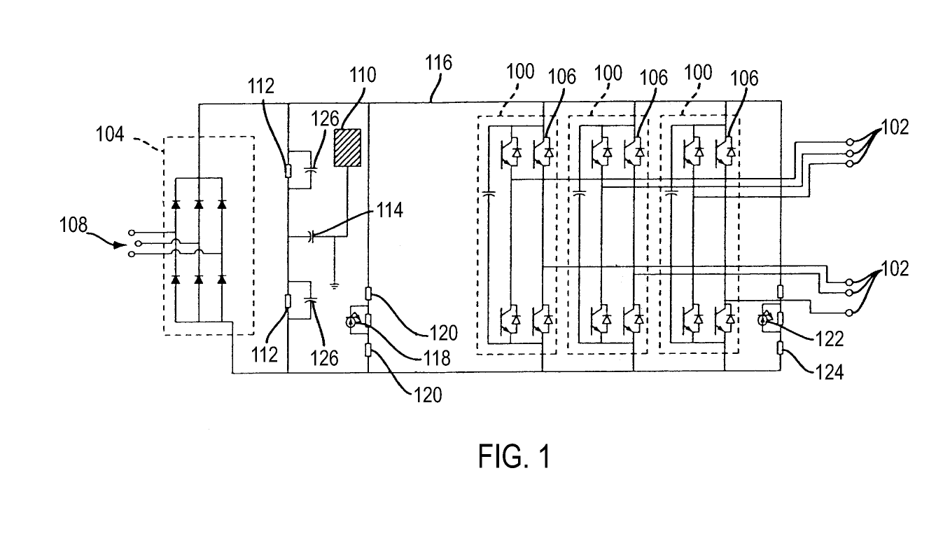

Turning to FIG. 1, an inverter circuit 100 may be capable of selectively adjusting the frequency and/or pulse-width of its output, such that motors connected at connection point 102 may be operated at variable speeds. In one embodiment, motors may be connected via final assemblies or directly to drive wheels of a machine. In alternative embodiments, such as a generator, the motors are used to generate electricity and are not connected to drive wheels.

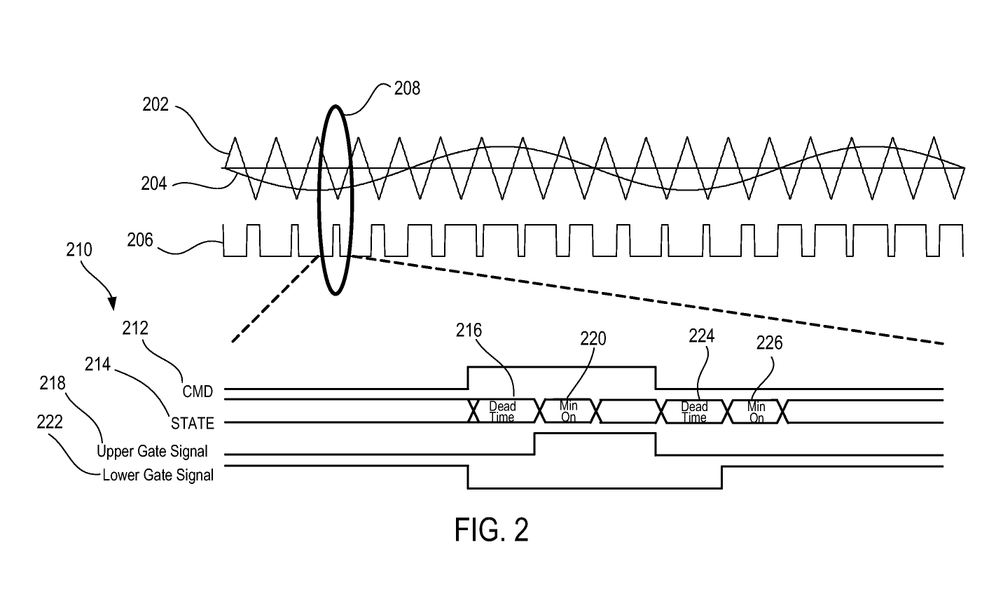

The inverter circuit 100 is connected in parallel with the rectifier 104 and operates to transform the DC voltage V into variable frequency sinusoidal or non-sinusoidal AC power. Any known inverter may be used for the arrangement of the inverter circuit 100. In the example shown in FIG. 1, the inverter circuit 100 includes three phase arrays of insulated-gate bipolar transistors (IGBT) 106 that are arranged in transistor pairs and that are configured to supply a 3-phase AC output to each drive motor connected at connection point 102. Each transistor pair acts as a switch for a particular phase of the three-phase power signal. In alternative embodiments, multi-phase systems other then three-phase are used. In response to signals received from a controller, the inverter circuit 100 can control the speed of the motors by controlling the frequency and/or the pulse-width of the AC output as shown in FIG. 2 and further described below. In one embodiment, an engine and alternator 108 supply the power necessary to drive the drive motors. In alternative embodiments, another source of power, such as a battery or contact with an electrified rail or cable are used. While the illustrated embodiment utilizes IGBTs in the inverter circuit 100, any high power switching technology may be used.

The embodiment for a drive system shown in FIG. 1 includes other components that are discussed for the sake of completeness. Such components are optional but are shown herein because they promote smooth and efficient operation of the system. In one exemplary embodiment, a leakage detector 110 is connected between the two resistors 112, in series with a capacitor 114, to the first and second rails of the DC link 116. The leakage detector 110 detects any current leakage to ground from either of the first and second rails of the DC link 116. Further, in one embodiment, a first voltage indicator 118 may be connected between resistors 120 across the first and second rails of the DC link 116. The first voltage indicator 118 may be disposed between the rectifier 104 and a retarder arrangement such that a high voltage condition may be detected. In a similar fashion, a second voltage indicator 122 may be connected between resistors 124 across the first and second rails of the DC link 116. The second voltage indicator 122 may be disposed between connection nodes 102 that connect to the motors and the inverter circuit 100 to detect a voltage condition occurring during, for example, a bus bar fracture where the DC link 116 is not continuous, in order to diagnose whether the inverter circuit 100 is operating.

In one embodiment, during operation, a voltage is developed across the first and second rails of the DC link 116 by the rectifier 104 and/or an inverter circuit 100. One or more capacitors 126 may be connected in parallel with one or more resistors 112 across the DC link 116 to smooth the voltage V across the first and second rails of the DC link 116. The DC link 116 exhibits a DC link voltage, V, which can be measured by a voltage transducer, and a current, A, which can be measured by a current transducer.

A simplified diagram illustrating one phase of the power generated by the inverter circuit 100 according to one embodiment is shown in FIG. 2. In one embodiment, the inverter circuit can control the speed of the motors by generating a pulse width modulated (PWM) output. In an alternative embodiment, the invertor circuit controls the voltage output of a generator. In one embodiment, the PWM signal 206 is generated using the intersective method. The intersective method uses a reference triangle waveform 202 and a reference voltage waveform 204. A triangle waveform 202 and reference voltage waveform 204 are used for each phase of a three phase signal. While the illustrated embodiment utilizes a triangle waveform to generate a PWM output, any method may be used to generate the PWM output. For example, in another embodiment, space vector modulation is utilized. A comparator may be used to compare the waveforms and determine when the value of the reference voltage waveform 204 intersects the reference triangle waveform 202, a controller commands the inverter circuit 100 to output a nominal high voltage for the PWM signal 206. In the example region 208, the reference waveform 204 intersects the triangle waveform 202. The PWM signal 206 is therefore in a nominally high state during the period of intersection.

The timing diagram 210 shows the signals used to generate the PWM signal 206 during region 208, when the value of the reference voltage waveform 204 intersects the reference triangle waveform 202. During the intersection, a CMD signal 212 is asserted. There is an inherent latency in the inverter circuit 100 from the time the CMD signal 212 changes to a high state until the output of the corresponding phase array of IGBT 106 changes to a high state. Additional time is needed to ensure that the upper and lower gates are not simultaneously on. The delay, taking into account at least the latency and additional time is referred to as dead time. State signal 214 illustrates the dead time 216. The state signal 214 can be maintained, for example, by a state machine. After the dead time 216, as shown in the upper gate signal 218, the IGBT 106 phase array's upper gate is asserted. The inverter circuit 100 and IGBT 106 have a minimum on time 220 after the IGBT 106 changes to a high state. The lower gate signal 222 is the output of the IGBT 106 phase array's lower gate. The upper gate signal 218 and lower gate signal 222 are generally the inverse of each other. However, due to dead time and minimum on times, the signals are not always inverses of each other. For, example, during dead time 216, the lower gate signal 222 can immediately transition to a low state, but the upper gate signal 218 does not transition until the end of the dead time 216. Likewise, during dead time 224 the upper gate signal 218 can immediately transition to a low state, but the lower gate signal 222 does not transition until the end of the dead time 224. Minimum on time 226 represents the time that the lower gate of the array of IGBT 106 must be held in a high state before transitioning to low state.

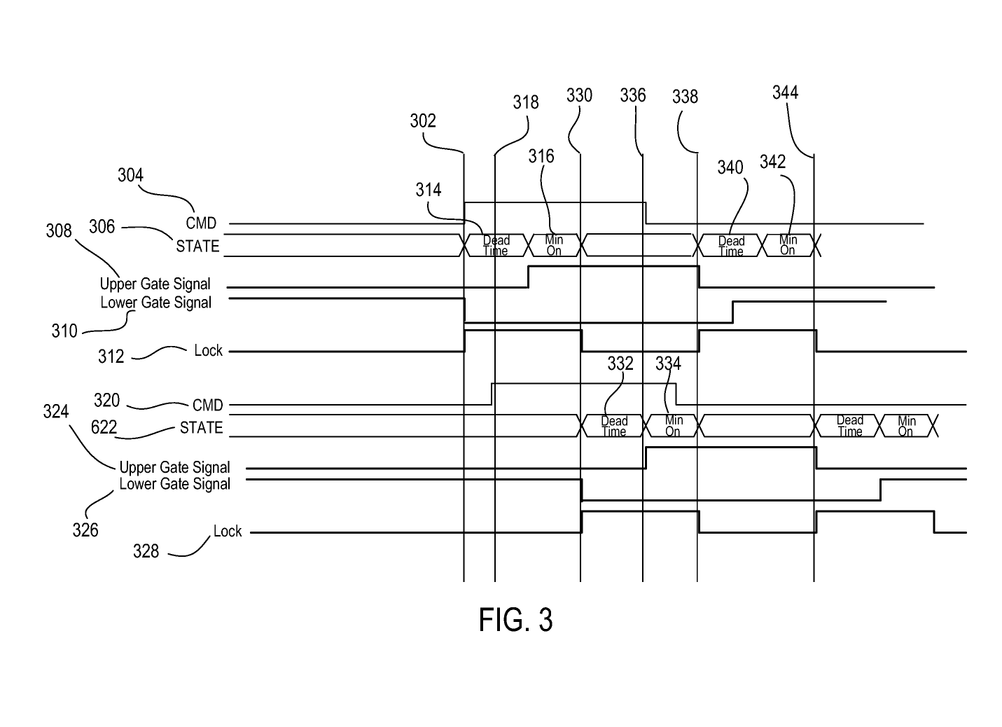

FIG. 3 illustrates a simplified timing diagram showing signals generated for two phases of the multi-phase power signal in accordance with one embodiment of the disclosure. At time 302, the first phase CMD signal 304 is asserted. The first phase state signal 306 indicates that the system has entered dead time 314. The first phase upper gate signal 308 remains low during the dead time 314. The first phase lower gate signal 310 immediately transitions to a low state at time 302. Additionally, a first phase lock signal 312 is asserted. The first phase lock signal 312 remains asserted during the dead time 314 and minimum on time 316. The first phase lock signal 312 is used to prevent the IGBT 106 arrays for the remaining phases from transitioning during the period the first phase in in dead time or minimum on time. The period of dead time and minimum on time is the time a phase is changing state.

At time 318, the second phase CMD signal 320 is asserted. However, the first phase lock signal 312 is asserted. Therefore, the second phase state signal 322, the second phase upper gate signal 324, the second phase lower gate signal 326 and the second phase lock signal 328 do not change states. At time 330, the first phase state signal indicates that dead time 314 and minimum on time 316 have ended. Therefore, the first phase lock signal 312 goes to a low state, indicating that the lock period has ended. The second phase CMD signal 320 is still asserted at time 330.

Therefore, at time 330 the second phase state signal 322 indicates that the system has entered dead time 332. The second phase upper gate signal 324 remains low during the dead time 332. The second phase lower gate signal 326 immediately transitions to a low state at time 330. Additionally, a second phase lock signal 328 is asserted. The second phase lock signal 328 remains asserted during the dead time 332 and minimum on time 334. The second phase lock signal 328 is used to prevent the IGBT 106 arrays for the remaining phases from transitioning during the period the first phase in in dead time or minimum on time.

At time 336 the first phase CMD signal 304 is deasserted. However, the second phase lock signal 328 remains asserted. Therefore, first phase state signal 306, first phase upper gate signal 308, first phase lower gate signal 310 and first phase lock signal 312 remain in their current states.

At time 338, the second phase state signal 322 indicates that the second phase has completed dead time 332 and minimum on time 334. Therefore, the second phase lock signal 328 is deasserted. The first phase CMD signal 304 remains deasserted. Therefore, the first phase state signal 306 indicates that the system is entering dead time 340, the first phase upper gate signal 308 immediately transitions to a low state and the lower gate signal 310 stays in a low state during the dead time 340. The first phase lock signal 312 is asserted to indicate that the first phase is in dead time 340 and minimum on time 342.

Between time 336 and time 338, the second phase CMD signal 320 is deasserted. However, the second phase is in minimum on time 334. Therefore, the second phase does not change state when the second phase CMD signal 320 transitions to a low state between time 336 and time 338. As discussed above, at time 338, the second phase completes its minimum on time 334. The first phase has been waiting since time 336, when the first phase CMD signal was deasserted, to transition. Therefore, at time 338 the first phase transitions.

At time 344, the first phase completes its dead time 340 and minimum on time 342. Therefore, the first phase lock signal 312 is deasserted at time 344. After the first phase lock signal 312 is deasserted, the second phase can make its transition, based on the second phase CMD signal being deasserted between time 336 and time 338. It should be noted that in this embodiment, the relative order of transitions on each phase is maintained. Additional phases may also exist. Each phase maintains its own lock signal and each phase must wait until lock signals on the other phases are deasserted. If the CMD signal 320 changes state during the assertion of another phase lock signal 312 and the CMD signal 320 returns to its original state while the lock signal remains asserted, the CMD transition will be ignored.

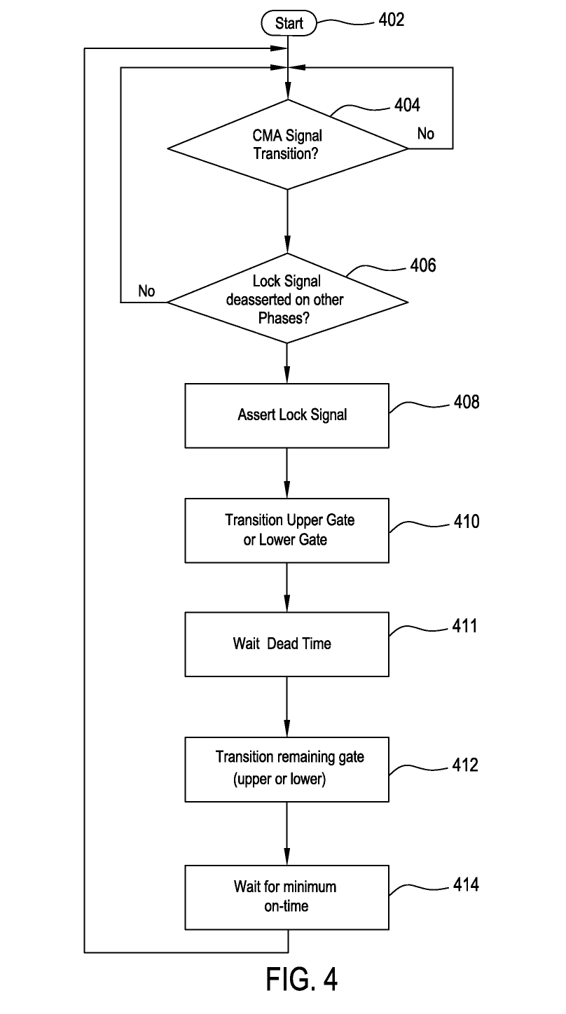

FIG. 4 is a flowchart for a method in accordance with one embodiment of the disclosure. The method illustrates a control scheme for one phase of a multi-phase power signal. The method is configured to prevent the IGBT 106 array for one phase of a multi-phase power signal from transitioning if another phases's IGBT 106 array is transitioning. The method may be implemented on a controller.

The method begins at 402. The controller determines whether a CMD signal 304 has made a transition at 404. The CMD signal 304 is compared to an applied command state signal. If the CMD signal 304 is different from the applied command state signal, the system continues to monitor the lock signals.

The process repeats, starting at 402. If the controller detects a transition, the controller next determines whether a lock signal is deasserted for the other phases of the three-phase power signal at 406. If another lock signal is asserted, the process repeats, starting at 402. If the other lock signals are deasserted, at 408 the controller asserts the lock signal for the current phase if the CMD signal does not match the applied command. At 410, the controller next transitions the upper gate or lower gate of the IGBT 106 array. Based on inherent latencies in the circuit, there may be a delay before the gate transitions at 410. The controller waits for the completion of the dead time at 411. At 412, the controller transitions the remaining gate that was not transitioned at 410. For example, if the upper gate was transitioned at 410, the lower gate will be transitioned at 412. The system asserts the CMD signal as requested. If the CMD is high, the upper gate is turned on. If the CMD is low, the lower gate is turned on. The controller waits for the completion of the minimum on time at 414, deasserts the lock signal and then the process repeats, starting at 402. The controller can be preprogramed with the dead time and minimum on time. Alternatively, the controller may determine the dead time by monitor the output of the IGBT 106 array.

It will be appreciated that the controllers discussed herein may comprise a computing device, e.g., a computer processor, which reads computer-executable instructions from a computer-readable medium and executes those instructions. Media that are readable by a computer include both tangible and intangible media. Examples of the former include magnetic discs, optical discs, flash memory, RAM, ROM, tapes, cards, etc. Examples of the latter include acoustic signals, electrical signals, AM and FM waves, etc. As used in the appended claims, the term “computer-readable medium” denotes only tangible media that are readable by a computer unless otherwise specifically noted in the claim. The controller discussed herein may include, but is not limited to, processors, discrete logic devices, field programmable gate arrays (FPGAs) and application specific integrated circuits (ASICs).

### INDUSTRIAL APPLICABILITY

The industrial applicability of the methods and systems for power management as described herein should be readily appreciated from the foregoing discussion. The present disclosure is applicable to many machines and many environments. One exemplary machine suited to the disclosure is a bulldozer. Other exemplary machines include off-highway trucks such as those commonly used in mines, construction sites, and quarries. However, the present disclosure is applicable to any electric multi-phase machine application.

AC motors may experience shortened life spans due to, for example, failures of the insulation around the motor stator. One cause of such failures is excessive voltage swings. The present disclosure may prevent such excessive voltage swings by limiting transitions to only one phase of a multi-phase power signal. Transitioning more then one phase at a time may lead to excessive voltage swings through the motor stator.

Bulldozers, particularly those adapted to use electric, hybrid, or direct series electric drive systems, are subject to sudden load changes, and it can often be difficult to accommodate such load changes. Thus, a method and system that can improve the speed and accuracy with which a machine responds to changing power demands can significantly increase operating efficiencies.

Further, the methods and systems described above can be adapted to a large variety of machines and tasks. For example, other types of industrial machines, including, but not limited to backhoe loaders, compactors, feller bunchers, forest machines, industrial loaders, skid steer loaders, wheel loaders and many other industrial machines can benefit from the methods and systems described.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A protection circuit for limiting an electrical voltage transition on at least a first phase and a second phase of a multi-phase power bus, the protection circuit comprising:
a first switch having a first upper gate configured to control a first upper gate signal and a first lower gate configured to control a first lower gate signal, the first switch configured to control the first upper gate and the first lower gate in response to a first command signal indicative of a desired state of the first switch and generate a first lock signal indicative of an electrical voltage transition on the first phase;
a second switch having a second upper gate configured to control a second upper gate signal and a second lower gate configured to control a second lower gate signal, the second switch configured to control the second upper gate and the second lower gate in response to a second command signal indicative of a desired state of the second switch and generate a second lock signal indicative of an electrical voltage transition on the second phase;
a third switch having a third upper gate configured to control a third upper gate signal and a third lower gate configured to control a third lower gate signal, the third switch configured to control the third upper gate and the third lower gate in response to a third command signal indicative of a desired state of the third switch and generate a third lock signal indicative of an electrical voltage transition on the third phase; and
a control circuit configured to control the first switch based on the first command signal and to control the second switch based on the second command signal and to control the third switch based on the third command signal, the control circuit further configured to prevent the first switch from changing state if one of the second lock signal indicates the second switch is changing state or the third lock signal indicates the third switch is changing state.

2. The protection circuit of claim 1 wherein the first upper gate and the first lower gate are insulated-gate bipolar transistors.

3. The protection circuit of claim 2 wherein the second upper gate and the second lower gate are insulated-gate bipolar transistors.

4. The protection circuit of claim 1 wherein the first upper gate and the second lower gate have a dead time and a minimum on time.

5. The protection circuit of claim 4 wherein the first lock signal is indicative of whether the first switch is changing state, in the dead time and in the minimum on time.

6. The protection circuit of claim 1 wherein the control circuit is a computer processor.

7. The protection circuit of claim 1 wherein the control circuit is one of a processor, a field programmable gate array and an ASIC.

8. The protection circuit of claim 7 further comprising a memory device programmed with computer readable instructions.

9. A controller for a multi-phase alternating current motor, the controller comprising:
a modulator for each phase of the multi-phase alternating current motor, each modulator configured to generate a pulse width modulated signal;
a switch for each phase of the multi-phase alternating current motor, each switch responsive to a command signal for its phase and configured to supply power to a phase of the multi-phase alternating current motor, each switch having a minimum on time and dead time after changing states and the controller having a latency between the command signal changing states and a output of each switch;
a lock generator for each phase of the multi-phase alternating current motor, each lock generator configured to generate a lock signal for a period during the latency between the command signal changing states and the output of the switch, the switch changing states, the minimum on time and the dead time of the switch; and
the controller coupled with each of the modulators, each of the switches and each of the lock generators configured to prevent each switch from changing states if the lock signal for one of the phases not associated with a particular switch is received.

10. The controller of claim 9 further comprising a processor configured as the lock generator for each phase of the multi-phase alternating current motor.

11. The controller of claim 9 wherein the modulator is one of a space vector modulator and a triangle wave modulator.

12. The controller of claim 9 wherein the switch for each phase of the multi-phase alternating current motor further comprises an upper gate configured to control an upper gate signal and a lower gate configured to control a lower gate signal.

13. The controller of claim 12 wherein the upper gate and the lower gate are insulated-gate bipolar transistors.

14. The controller of claim 13 wherein the insulated-gate bipolar transistors have a dead time and a minimum on time.

15. A method of controlling a multi-phase alternating current motor having a multi-phase power signal, the method comprising:
generating, for each phase of the multi-phase alternating current motor, a command signal indicative of whether power should be supplied to a particular phase;
supplying power to a phase associated with the multi-phase alternating current motor using a switch having a minimum on time after changing states and a latency between a command to change states and the output of the switch;
generating a lock signal for a period during the minimum on time after changing states, the latency between the command to change states and the output of the switch and a dead time; and
preventing the switch from changing states if the lock signal for another phase indicates another phase is changing states.

16. The method of claim 15 further comprising rotating the multi-phase alternating current motor.

17. The method of claim 15 wherein the switch comprises two insulated-gate bipolar transistors.

18. The method of claim 15 further comprising receiving a signal indicative of whether another phase is changing states.

19. The method of claim 18 wherein a phase is changing states during a dead time, a minimum on time and the latency between a command to change states and the output of a switch associated with the phase.

20. The method of claim 17 wherein the insulated-gate bipolar transistors have a dead time and a minimum on time.
